(19) United States
(12) Patent Application Publication
(10) Pub. No.: US 2012/0070623 A1
(43) Pub. Date: Mar. 22, 2012

(54) MANUFACTURING METHOD OF LAMINATED BODY, STAMPER, TRANSFER DEVICE, LAMINATED BODY, MOLDING ELEMENT, AND OPTICAL ELEMENT

(75) Inventors: Kazuya Hayashibe, Miyagi (JP); Hiroshi Tazawa, Miyagi (JP)

(73) Assignee: SONY CORPORATION, Tokyo (JP)

(21) Appl. No.: 13/232,464

(22) Filed: Sep. 14, 2011

(30) Foreign Application Priority Data
Sep. 17, 2010 (JP) 2010-210241
Oct. 22, 2010 (JP) 2010-237331

(51) Int. Cl. B32B 3/30; B29C 59/16; B29C 59/04; B05D 3/12; B05D 3/06

(52) U.S. Cl. 428/172; 427/487; 425/174.4

(57) ABSTRACT

A manufacturing method of a laminated body includes applying an energy ray curable resin composition on a base, and causing a rotation surface of a rotation stamper to come into close contact with the energy ray curable resin composition applied on the base during rotation, and irradiating the energy ray curable resin composition with energy rays emitted from one or a plurality of energy ray sources provided in the rotation stamper via the rotation surface so as to cure the energy ray curable resin composition, thereby forming a shape layer onto which concave and convex shapes of the rotation surface are transferred, on the base.

### CROSS REFERENCES TO RELATED APPLICATIONS

The present application claims priority to Japanese Priority Patent Application JP 2010-210241 filed in the Japan Patent Office on Sep. 17, 2010 and Japanese Priority Patent Application JP 2010-237331 filed in the Japan Patent Office on Oct. 22, 2010, the entire contents of which are hereby incorporated by reference.

### BACKGROUND

The present disclosure relates to a manufacturing method of a laminated body, a stamper, a transfer device, a laminated body, a molding element, and an optical element. More particularly, the present disclosure relates to a manufacturing method of a laminated body having a shape layer on a base, a stamper, a transfer device, a laminated body, a molding element, and an optical element.

In recent years, as methods of giving concave and convex shapes to a base, there have been used a method of using thermoplastic materials (hereinafter, referred to as a thermal transfer method), and a method of using photo curable materials (hereinafter, referred to as an optical transfer method) (for example, refer to Japanese Unexamined Patent Application Publication Nos. 2006-26873 and 2006-216836). In the thermal transfer method, a laminated body having concave and convex shapes on a base can be obtained by pressing a stamper to the base which is heated to a glass transition temperature or more, then cooling the base, and peeling the stamper from the base. In the optical transfer method, a laminated body can be obtained by tightly pressing a stamper to a photo curable material which is not cured on a base, irradiating the photo curable material with light through the stamper or the base, and curing the photo curable material, without heating the base.

The photo curable method has an advantage in that throughput can be improved further than in the thermal transfer method, and thus has attracted a particular attention recently. In the photo transfer method, generally, a metal stamper or a glass stamper is used. In a technique of manufacturing a planarized or rotation cyclic stamper as a technique of manufacturing the metal stamper, since light may not be applied from the stamper side, only a base which transmits light of a wavelength contributing to curing a photo curable material therethrough can be used, and a base which does not transmit light therethrough (non-transmissive base) may not be used.

In the glass stamper, light can be applied from the stamper side, and thus a laminated body having the concave and convex shapes can be obtained using a base which does not transmit light contributing to curing the photo curable material therethrough. In the manufacturing technique in the related art, since only a disk-shaped or plate-shaped stamper which is limited to sizes of several inches has been manufactured, in a case of manufacturing a laminated body having a size equal to or more than the area of the molding surface of the stamper, a step and repeat method has been used. However, in the step and repeat method, mismatching between concave and convex shapes occurs in the interface between transfer regions which have been transferred at the respective steps. The mismatching in the interface may cause characteristics of the laminated body to be deteriorated according to the kind of laminated body.

### SUMMARY

It is desirable to provide a manufacturing method of a laminated body which a non-transmissive base and a transfer region having no mismatching, a stamper, a transfer device, a laminated body which has a non-transmissive base and has no mismatching between concave and convex shapes on a surface of a shape layer, a molding element, and an optical element.

According to an embodiment of the present disclosure, there is provided a manufacturing method of a laminated body including applying an energy ray curable resin composition on a base; and causing a rotation surface of a rotation stamper to come into close contact with the energy ray curable resin composition applied on the base during rotation, and irradiating the energy ray curable resin composition with energy rays emitted from one or a plurality of energy ray sources provided in the rotation stamper via the rotation surface so as to cure the energy ray curable resin composition, thereby forming a shape layer onto which concave and convex shapes of the rotation surface are transferred, on the base.

According to another embodiment of the present disclosure, there is provided a transfer device including a rotation surface having concave and convex shapes; and a rotation stamper having one or a plurality of energy ray sources provided inside the rotation surface, wherein the rotation stamper has a transmissive property with respect to energy rays emitted from the energy ray source, and wherein the rotation surface of the rotation stamper comes into close contact with an energy ray curable resin composition applied on a base during rotation, and the energy ray curable resin composition is irradiated with the energy ray emitted from the energy ray source provided in the rotation stamper via the rotation surface so as to cure the energy ray curable resin composition, thereby forming a shape layer onto which concave and convex shapes of the rotation surface are transferred, on the base.

According to still another embodiment of the present disclosure, there is provided a stamper including a rotation surface having concave and convex shapes, wherein the stamper has a transmissive property with respect to energy rays emitted from an energy ray source, and wherein the stamper causes an energy ray curable resin composition to be irradiated with the energy ray emitted from the energy ray source via the rotation surface, thereby curing the energy ray curable resin composition.

According to still another embodiment of the present disclosure, there is provided a laminated body including a base; and a shape layer having a surface which is formed on the based and has concave and convex shapes, wherein the shape layer is formed by curing an energy ray curable resin composition, wherein a unit region having a predetermined concave and convex pattern is continuously formed on the surface of the shape layer without generating mismatching between the concave and convex shapes, and wherein the base has a non-transmissive property with respect to energy rays for curing the energy ray curable resin composition.

According to still another embodiment of the present disclosure, there is provided a laminated body including a base having a first surface and a second surface opposite to the first surface; a first shape layer formed on the first surface of the base; and a second shape layer formed on the second surface of the base, wherein the first shape layer is formed by curing an energy ray curable resin composition, wherein at least the second shape layer of the first and second shape layers has a non-transmissive property with respect to energy rays for curing the energy ray curable resin composition, and wherein a unit region having a predetermined concave and convex pattern is continuously formed on a surface of the first shape layer without generating mismatching between the concave and convex shapes.

In the embodiments of the present disclosure, the energy ray curable resin composition indicates a composition including an energy ray curable resin composition as a main component. Ingredients other than the energy ray curable resin composition may use, for example, a heat curable resin, a silicon resin, an organic particle, an inorganic particle, a conductive macromolecule, metal powder, pigment, and the like, but are not limited thereto, and various materials may be used according to characteristics of desired laminated bodies.

In addition, the non-transmissive property with respect to energy rays indicates a non-transmissive property of an extent that it is difficult to cure an energy ray curable resin composition.

The unit region is preferably a transfer region formed by rotating a rotation surface of a rotation stamper. The rotation stamper preferably uses a roll stamper or a belt stamper, but is not limited thereto as long as it includes a rotation surface on which concave and convex shapes are formed.

Arrangements of the structure body are preferably a regular arrangement, an irregular arrangement, and a combination thereof. The arrangement of the structure body is preferably a one-dimensional arrangement or a two-dimensional arrangement. A shape of the base preferably uses a shape such as a film shape or a plate shape having two main surfaces, a polyhedral shape having three or more main surfaces, a curved shape having a curve such as a spherical surface and an adjustable curve, a polyhedral shape having a plane and a spherical surface, and the like. The shape layer is preferably formed on at least one of a plurality of main surfaces which the base has. The base has at least one plane or curve, and the shape layer is preferably formed on the plane or the curve.

In the embodiments of the present disclosure, since the concave and convex shapes are connected to each other without generating mismatching between the unit regions, there is no characteristic deterioration of a laminated body or shape disarray caused by mismatching between the unit regions. Therefore, it is possible to obtain a laminated body having excellent characteristics or an exterior. In a case where the concave and convex shapes are patterns of a lens or a sub-wavelength structure body, or the like, it is possible to obtain excellent optical characteristics even between the unit regions. In a case of a design by exchanging concave and convex shapes with predetermined shapes, it is possible to obtain a design of shapes or the like having no mismatching parts. In addition, since a base having a non-transmissive property with respect to an energy ray can be used, it is possible to use a variety of bases.

As described above, according to the embodiments of the present disclosure, mismatching does not occur in concave and convex shapes on a shape layer surface, and thus it is possible to obtain a laminated body having excellent characteristics or an exterior. In addition, various bases can be used as the base, and thus a laminated body is applicable to various molding elements or optical elements.

Additional features and advantages are described herein, and will be apparent from the following Detailed Description and the figures.

### BRIEF DESCRIPTION OF THE FIGURES

FIG. 1A is a plan view illustrating an example of a laminated body according to a first embodiment of the present disclosure. FIG. 1B is an enlarged perspective view of a part of the laminated body shown in FIG. 1A. FIG. 1C is an enlarged plan view of a part of the laminated body shown in FIG. 1A. FIG. 1D is a cross-sectional view of the laminated body shown in FIG. 1C in the track extending direction.

FIGS. 2A to 2E are cross-sectional views illustrating first to fifth examples of bases provided in the laminated body according to the first embodiment of the present disclosure.

FIG. 3 is a schematic diagram illustrating an example of a configuration of a transfer device according to the first embodiment of the present disclosure.

FIG. 4A is a perspective view illustrating an example of a configuration of a roll stamper. FIG. 4B is an enlarged plan view of a part of the roll stamper shown in FIG. 4A.

FIG. 5 is a schematic view illustrating an example of a configuration of a roll stamper exposure device.

FIGS. 6A to 6D are process diagrams illustrating an example of a manufacturing method of the laminated body according to the first embodiment of the present disclosure.

FIGS. 7A to 7E are process diagrams illustrating an example of a manufacturing method of the laminated body according to the first embodiment of the present disclosure.

FIG. 8 is a schematic diagram illustrating an example of a configuration of a transfer device according to a second embodiment of the present disclosure.

FIG. 9 is a schematic diagram illustrating an example of a configuration of a transfer device according to a third embodiment of the present disclosure.

FIGS. 10A and 10B are a plan view illustrating an example of a configuration of a laminated body according to a fourth embodiment of the present disclosure.

FIG. 11A is a schematic diagram illustrating an example of a configuration of a laminated body according to a fifth embodiment of the present disclosure. FIG. 11B is an enlarged plan view of a part of the laminated body shown in FIG. 11A. FIG. 11C is a cross-sectional view of the laminated body shown in FIG. 11B.

FIG. 12 is a perspective view illustrating an example of a laminated body according to a sixth embodiment of the present disclosure.

FIGS. 13A to 13E are cross-sectional views illustrating first to fifth examples of bases provided in a laminated body according to a seventh embodiment of the present disclosure.

FIGS. 14A and 14B are cross-sectional views illustrating first and second examples of bases provided in a laminated body according to an eighth embodiment of the present disclosure.

### DETAILED DESCRIPTION

Embodiments of the present application will be described below in detail with reference to the drawings.

1. FIRST EMBODIMENT (an example of a laminated body where a plurality of structure bodies are arranged in a two-dimensional manner on one main surface of a base)

2. SECOND EMBODIMENT (an example of a transfer device which carries a laminated body using a stage)

3. THIRD EMBODIMENT (an example of a transfer device having a toric belt stamper)

4. FOURTH EMBODIMENT (an example of a laminated body where a plurality of structure bodies are arranged to be wobbled on one main surface of a base)

5. FIFTH EMBODIMENT (an example of a laminated body where a plurality of structure bodies are arranged randomly on one main surface of a base)

6. SIXTH EMBODIMENT (an example of a laminated body where a plurality of structure bodies are arranged in a one-dimensional manner on one main surface of a base)

7. SEVENTH EMBODIMENT (an example of a laminated body where a plurality of structure bodies are arranged in a two-dimensional manner on both main surfaces of a base)

8. EIGHTH EMBODIMENT (an example of a laminated body where a plurality of non-transmissive structure bodies are arranged in a two-dimensional manner)

### 1. First Embodiment

Configuration of Laminated Body

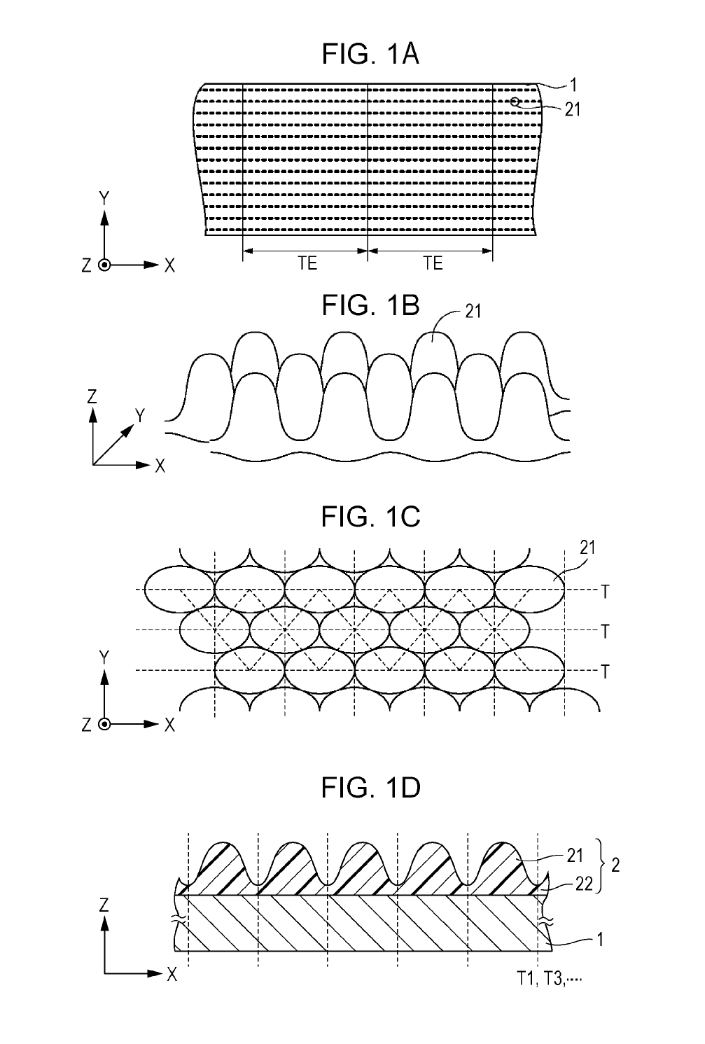

FIG. 1A is a plan view illustrating an example of a laminated body according to a first embodiment of the present disclosure. FIG. 1B is an enlarged perspective view of a part of the laminated body shown in FIG. 1A. FIG. 1C is an enlarged plan view of a part of the laminated body shown in FIG. 1A. FIG. 1D is a cross-sectional view of the laminated body shown in FIG. 1C in the track extending direction. A laminated body includes a base 1 having a first main surface and a second main surface, and a shape layer 2 which is formed on one of the main surfaces and has concave and convex shapes. Hereinafter, the first main surface on which the shape layer 2 is formed is referred to as a front surface, and the second surface opposite thereto is referred to as a rear surface.

The laminated body is appropriately applied to a surface texturing body, a design body, a molding element such as a mechanical element or a medical element, and an optical element such as antireflection element, a polarization element, a periodical optical element, a diffractive element, an image forming element or a light guide element. Specifically, the laminated body is appropriately applied to various kinds of filters adjusting light amount such as an ND filter, a sharp cutoff filter, and an interference filter, polarizers, front panel plates of mobile phones and instrument panels of automobiles, texturing of mobile phones or the like, resin moldings, and glass moldings.

The laminated body has, for example, a strip shape, is wound in a roll shape, and is a so-called original fabric. The laminated body is preferably flexible. Thereby, the strip-shaped laminated body is wound in a roll shape and thus a carrying property or a handling property is improved.

As shown in FIG. 1A, the laminated body has, for example, at least one cyclic transfer region (unit region) TE. Here, the one cyclic transfer region TE is a region for which transfer is performed by rotating a roll stamper described later by one rotation. That is to say, the length of the one cyclic transfer region TE corresponds to the length of the peripheral surface of the roll stamper. In the interface between two adjacent transfer regions TE, it is preferable that mismatching between the concave and convex shapes of the shape layer 2 be not present and the two transfer regions TE be connected in a seamless manner. This allows a laminated body having excellent characteristics or an exterior to be obtained. Here, the mismatching indicates that a physical configuration of the concave and convex shapes due to the structure bodies 21 is discontinuous. Detailed examples of the mismatching include disarray of periodicity of predetermined concave and convex patterns on the transfer region TE, overlapping or a gap between adjacent unit regions, a portion where transfer is not performed, and the like.

Base

A material of the base 1 is not particularly limited but may be selected according to the usage, and, for example, may use quartz, plastic such as methyl methacrylate (co)polymer, polycarbonate, styrene (co)polymer, methyl methacrylate-styrene copolymer, cellulose diacetate, cellulose triacetate, cellulose acetate butyrate, polyester, polyamide, polyimide, polyether sulfone, polysulfone, polypropylene, polymethylpentene, polyvinyl chloride, polyvinyl acetal, polyether ketone, polyurethane, cyclo-olefin polymer, cyclo-olefin copolymer, glass, metal, ceramics, magnetic bodies, and semiconductors. A shape of the base 1 includes, for example, a sheet shape, a plate shape, and a block shape, but is not particularly limited to such shapes. Here, a definition of the sheet includes a film. The entire base 1 has a strip shape, and the transfer region TE as the unit region is preferably continuously formed in the longitudinal direction of the base 1. Shapes of the front surface and the rear surface of the base 1 may use, for example, both of a plane and a curve. Both the front and rear surfaces may have the form of a plane or curve, and one of the front and rear surfaces may have the form of a plane, and the other surface a curve.

The base 1 has a non-transmissive property with respect to energy rays used to cure an energy ray curable resin composition for forming the shape layer 2. In the present specification, the energy rays indicate energy rays for curing an energy ray curable resin composition used to form the shape layer 2. For example, a decoration layer or a functional layer may be formed on the front surface of the base 1 through printing, application, vacuum deposition, or the like.

The base 1 has a single layer structure or a laminated structure. Here, the laminated structure is formed by laminating two or more layers, and at least one layer of the laminated structure is a non-transmissive layer with respect to the energy ray. Examples of a method of forming the laminated body include a method of pasting between layers through fusion or a surface treatment, a method of pasting between layers via a pasting layer such as an adhesive layer or a sticky layer, but are not particularly limited. The pasting layer may include materials such as pigments absorbing energy rays. In addition, in a case where the base 1 has the laminated structure, there may be a combination of a non-transmissive layer having the non-transmissive property with respect to energy rays and a transmissive layer having a transmissive layer with respect to the energy rays. Further, in a case where the base has two or more non-transmissive layers, the layers may have absorption characteristics different from each other.

A material of the transmissive layer may use, for example, a transparent organic film such as an acryl resin coated material, a transparent metal film, an inorganic film, a metal compound film, or a laminated body thereof, but is not particularly limited. A material of the non-transmissive layer may use, for example, an organic film such as an acryl resin coated material containing pigments, a metal film, a meal compound film, or a laminated body thereof, but is not particularly limited. The pigments may use, for example, materials such as a carbon black or the like having a light absorption property.

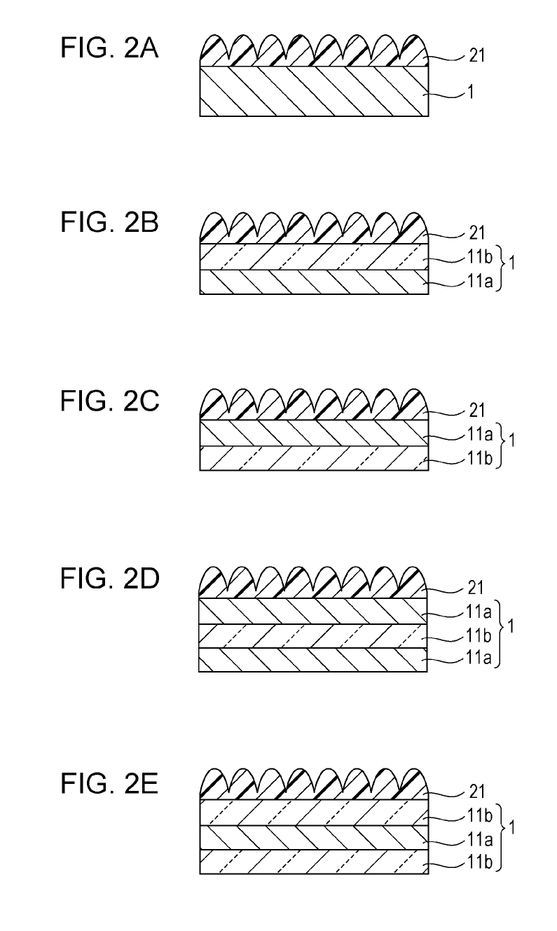

FIGS. 2A to 2E are cross-sectional views illustrating first to fifth examples of the base.

### First Example

As shown in FIG. 2A, the base 1 has a single layer structure, and the overall base is a non-transmissive layer having a non-transmissive property with respect to energy rays.

### Second Example

As shown in FIG. 2B, the base 1 has a double-layer structure, and includes a non-transmissive layer 11a having a non-transmissive property with respect to energy rays and a transmissive layer 11b having a transmissive property with respect to energy rays. The non-transmissive layer 11a is disposed at the rear surface side, and the transmissive layer 11b is disposed at the front surface side.

### Third Example

As shown in FIG. 2C, the base 1 has a double-layer structure, and includes a non-transmissive layer 11a having a non-transmissive property with respect to energy rays and a transmissive layer 11b having a transmissive property with respect to energy rays. The non-transmissive layer 11a is disposed at the front surface side, and the transmissive layer 11b is disposed at the rear surface side.

### Fourth Example

As shown in FIG. 2D, the base 1 has a triple-layer structure, and includes a transmissive layer 11b having a transmissive property with respect to an energy ray, and, non-transmissive layers 11a and 11a, formed on both main surfaces of the transmissive layer 11b, having a non-transmissive property with respect to energy rays. One non-transmissive layer 11a is disposed at the rear surface side and the other non-transmissive layer 11a is disposed at the front surface side.

### Fifth Example

As shown in FIG. 2E, the base 1 has a triple-layer structure, and includes a non-transmissive layer 11a having a non-transmissive property with respect to energy rays, and, transmissive layers 11b and 11b, formed on both main surfaces of the non-transmissive layer 11a, having a transmissive property with respect to energy rays. One transmissive layer 11b is disposed at the rear surface side and the other transmissive layer 11b is disposed at the front surface side.

Shape Layer

The shape layer 2 has a surface on which the transfer region TE having a predetermined concave and convex pattern is continuously formed. The shape layer 2 is a layer where, for example, a plurality of structure bodies 21 are arranged in a two-dimensional manner, and may optionally have a basal layer 22 between the plurality of structure bodies 21 and the base 1. The basal layer 22 is a layer which is integrally formed with the structure bodies 21 at the bottom surface side, and is formed by curing an energy ray curable resin composition in the same manner as the structure bodies 21. The thickness of the basal layer 22 is not particularly limited but may be appropriately selected as necessary. The plurality of structure bodies 21 are arranged so as to form a plurality of lines of tracks T on the front surface of the base 1. The plurality of structure bodies 21 arranged so as to form a plurality of lines of tracks T may have a predetermined batch pattern where, for example, a square grid or a hexagonal grid is regularly arranged. The heights of the structure bodies 21 may be varied regularly or irregularly on the front surface of the base 1.

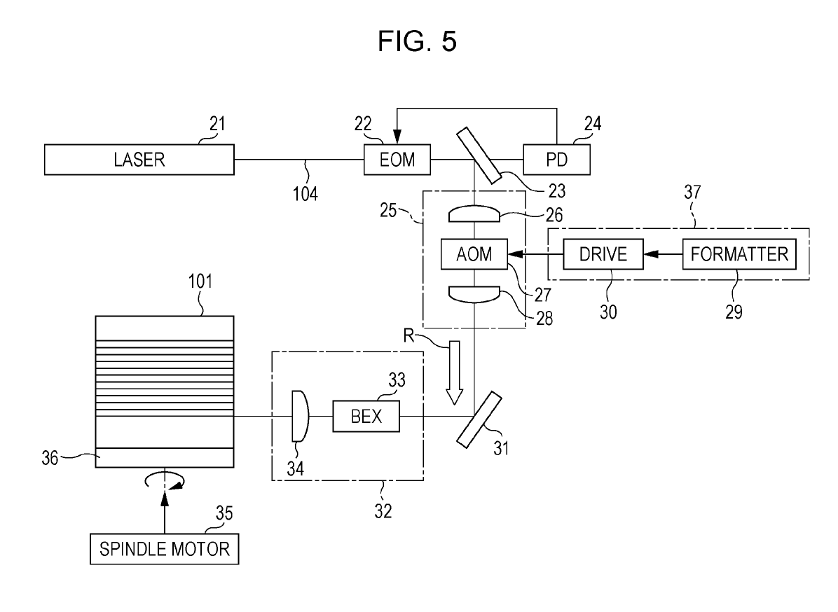

The structure bodies 21 may have a concave shape or a convex shape on the front surface of the base 1, or may have both the concave and convex shapes on the front surface of the base 1. Detailed examples of a shape of the structure body 21 include a pyramidal shape, a columnar shape, a needle shape, a hemisphere, a spherical semi-elliptical shape, a polygonal shape, and the like, but are not particularly limited thereto, and may have other shapes. Examples of the pyramidal shape include a pyramidal shape of which a top is sharpened or planarized, and a pyramidal shape of which a top has a convex curve or a concave curve, but are not limited to such shapes. In addition, the pyramidal surface of the pyramidal shape may be bent in a concave or convex shape. As a shape of the structure bodies 21, if a roll stamper is manufactured using a roll stamper exposure device (refer to FIG. 5) described later, it is preferable that an elliptic cone shape of which a top has a convex shape or a circular truncated cone of which a top is planarized be employed, and the long axis direction of the elliptical shape forming the bottom thereof corresponds with the extending direction of the track.

The pitch of the structure bodies 21 is appropriately selected depending on the kind of laminated body. For example, in a case where the laminated body is an optical element of a sub-wavelength structure body or the like for light antireflection, the structure bodies 21 are periodically disposed in a two-dimensional manner at a short disposition pitch equal to or less than a wavelength bandwidth for reducing reflection, for example, at a disposition pitch which is substantially the same as the wavelength of the visible light. The wavelength bandwidth of light for reducing reflection is, for example, a wavelength bandwidth of the ultraviolet light, a wavelength bandwidth of the visible light, or a wavelength bandwidth of the infrared light. Here, the wavelength bandwidth of the ultraviolet light is 10 nm to 400 nm, the wavelength bandwidth of the visible light is 400 nm to 830 nm, or the wavelength bandwidth of the infrared light is 830 nm to 1 mm.

The shape layer 2 is formed by curing an energy ray curable resin composition. The shape layer 2 is preferably formed by performing a curing reaction such as polymerization for an energy ray curable resin composition applied on the base 1 from an opposite side to the base 1. This is because a base having a non-transmissive property with respect to an energy ray can be used as the base 1. The transfer regions TE are preferably connected to each other without generating mismatching in a curing extent of the energy ray curable resin composition. The mismatching in the curing extent of the energy ray curable resin composition is, for example, a difference in the degree of polymerization.

The energy ray curable resin composition is a resin composition which can be cured by energy ray irradiation. The energy ray indicates energy rays which can form a trigger for a polymerization reaction such as a radical, cation or anion, of an electron beam, ultraviolet rays, infrared rays, a laser beam, visible rays, ionizing radiation (X-rays, α-rays, β-rays, γ-rays, and the like), microwaves, radio frequency, or the like. The energy ray curable resin composition may be optionally used by being mixed with other resins, and, for example, may be used by being mixed with other resins, such as a heat curable resin. In addition, the energy ray curable resin composition may be made of an organic and inorganic hybrid material. Further, more than two kinds of energy ray curable resin compositions may be mixed to be used. The energy ray curable resin composition preferably uses an ultraviolet curable resin which is cured by ultraviolet rays.

The ultraviolet curable resin is made of, for example, monofunctional monomer, bifunctional monomer, multifunctional monomer, initiator, or the like, and, specifically, is formed by using the following materials singly or a mixture thereof.

Examples of the monopolymer monomer include carboxylic acid (acrylic acid), hydroxy(2-hydroxyethyl acrylate, 2-hydroxypropyl acrylate, 4-hydroxybutyl acrylate), alkyl, alicyclics (isobutyl acrylate, t-butyl acrylate, isooctyl acrylate, lauryl acrylate, stearyl acrylate, isovinyl acrylate, cyclohexyl acrylate), other functional monomers (2-methoxyethyl acrylate, methoyethylene glycol acrylate, 2-ethoxyethyl acrylate, tetrahydrofurfryl acrylate, benzyl acrylate, ethylcarbitol acrylate, phenoxyethyl acrylate, N,N-dimethylethyl acrylate, N,N-dimethylaminopropylacrylamide, N,N-dimethylacrylamide, acryloylmorpholine, N-isopropylacrylamide, N,N-diethylacrylamide, N-vinylpyrrolidone), 2-(perfluorooctyl)ethyl acrylate, 3-perfluorohexyl-2-hydroxypropyl acrylate, 3-perfluorooctyl-2-hydroxypropyl acrylate, 2-(perfluorodecyl)ethyl acrylate, 2-(perfluoro-3-methylbutyl)ethyl acrylate, 2,4,6-tribromophenol acrylate, 2,4,6-tribromophenol methacrylate, 2-(2,4,6-tribromophenoxy)ethyl acrylate, 2-ethylhexyl acrylate, and the like.

Examples of the bifunctional monomer include tri(propyleneglycol) diacrylate, trimethylolpropane, diallyl ether, urethane acrylate, and the like.

Examples of the multifunctional monomer include trimethylolpropane triacrylate, dipentaerythritol penta-/hexa-acrylate, di-trimethylolpropane tetraacrylate, and the like.

Examples of the initiator include 2,2-dimethoxy-1,2-diphenylethan-1-one, 1-hydroxy-cyclohexylphenylketone, 2-hydroxy-2-methyl-1-phenylpropane-1-one, and the like.

In addition, the energy ray curable resin composition may optionally include a filler, a functional additive, a solvent, an inorganic material, a pigment, an antistatic agent, a sensitizing dye, and the like. The filler may use, for example, both of inorganic and organic particles. Examples of the inorganic particle include metal oxide particles such as SiO2, TiO2, ZrO2, SnO2, Al2O3, and the like. Examples of the functional additive include a leveling agent, a surface conditioner, an absorbent, an antifoaming agent, and the like.

Configuration of Transfer Device

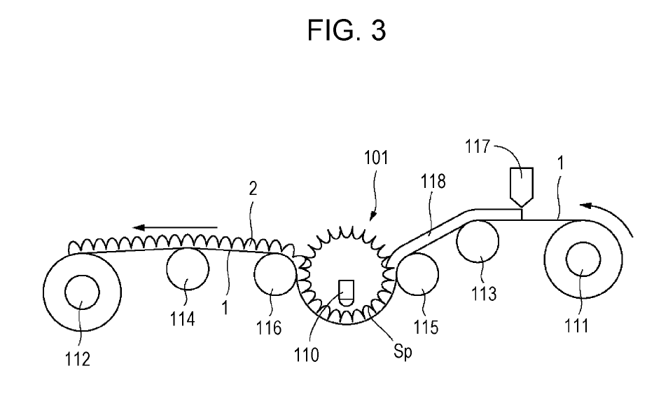

FIG. 3 is a schematic diagram illustrating an example of a configuration of a transfer device according to the first embodiment of the present disclosure. The transfer device includes a roll stamper 101, a base supply roll 111, a wind-up roll 112, guide rolls 113 and 114, a nip roll 115, a peeling roll 116, an application unit 117, and a light source 110.

The base 1 having a sheet shape or the like is wound on the base supply roll 111 in a roll shape, and the base supply roll 111 is disposed such that the base 1 is continuously sent via the guide roll 113. The wind-up roll 112 is disposed so as to wind up a laminated body having the shape layer 2 onto which concave and convex shapes are transferred by the transfer device. The guide rolls 113 and 114 are disposed in the carrying path of the transfer device such so as to carry the strip-shaped base 1 and the strip-shaped laminated body. The nip roll 115 is disposed so as to nip the base 1 which is sent from the base supply roll 111 and with which an energy ray curable resin composition is applied, with the roll stamper 101. The roll stamper 101 has a transfer surface for forming the shape layer 2, and includes one or a plurality of energy ray sources 110. A detailed description of the roll stamper 101 will be described later. The peeling roll 116 is disposed so as to peel the shape layer 2 obtained by curing the energy ray curable resin composition 118 from the transfer surface of the roll stamper 101.

Materials of the base supply roll 111, the wind-up roll 112, the guide rolls 113 and 114, the nip roll 15 and the peeling roll 116 are not particularly limited, but may use metal such as stainless steel, rubber, silicon, and the like through appropriate selection according to a desired roll characteristic. The application unit 117 may use, for example, a device having an application unit such as a coater. As the coater, for example, a gravure, a wire bar, and a die may be appropriately used in consideration of the physical characteristics of the energy ray curable resin composition to be applied.

Configuration of Roll Stamper

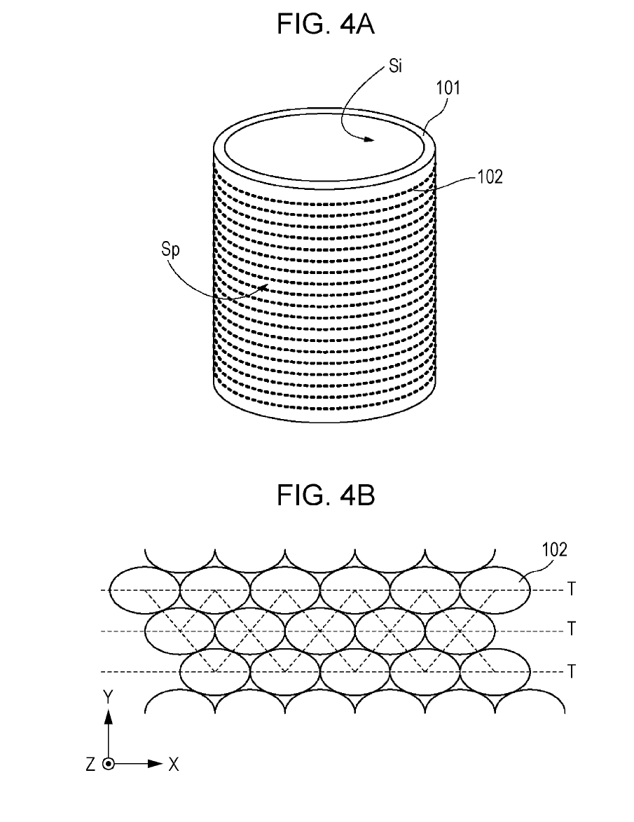

FIG. 4A is a perspective view illustrating an example of a configuration of the roll stamper. FIG. 4B is an enlarged plan view of a part of the roll stamper shown in FIG. 4A. The roll stamper 101 is a stamper having, for example, a cylindrical shape, and has a transfer surface Sp formed on the surface, and a rear surface Si which is an inner peripheral surface formed inside to be opposite thereto. For example, columnar hollow portions formed by the rear surface Si are formed inside the roll stamper 101, and one or a plurality of energy ray sources 110 may be provided in the hollow portions. The transfer surface Sp is provided with a plurality of structure bodies 102 having, for example, a concave shape or a convex shape, and the shape of the structure bodies 102 is transferred onto the energy ray curable resin composition applied on the base 1, thereby forming the shape layer 2 of the laminated body. The transfer surface Sp has the pattern obtained by reversing the concave and convex shapes of the shape layer 2 of the laminated body.

The roll stamper 101 has a transmissive property with respect to energy rays radiated from the energy ray sources 110 and emits the energy ray which is radiated from the energy ray sources 110 and is incident to the rear surface Si, from the transfer surface Sp. The energy ray curable resin composition 118 applied on the base 1 is cured by the energy ray emitted from the transfer surface Sp. A material of the roll stamper 101 preferably has a transmissive property with respect to energy rays and is not particularly limited. A material having a transmissive property with respect to ultraviolet rays preferably uses glass, quartz, a transparent resin, an organic and inorganic hybrid material, or the like. Examples of the transparent resin include polymethylmethacrylate (PMMA), polycarbonate (PC), and the like. Examples of the organic and inorganic hybrid material include polydimethylsiloxane (PDMS). A transparent metal film, metal compound film, or inorganic film may be formed on at least one of the transfer surface Sp and the rear surface Si of the roll stamper 101.

One or a plurality of energy ray sources 110 are supported inside the hollow portions of the roll stamper 101 so as to face and irradiate the energy ray curable resin composition 118 applied on the base 1 with the energy ray. In a case where the roll stamper 101 includes a plurality of energy ray sources 110, the energy ray sources 110 are preferably disposed so as to form one line or two or more lines. The energy ray source may be a source which can emit energy rays such as an electron beam, ultraviolet rays, infrared rays, a laser beam, visible rays, ionizing radiation (X-rays, α-rays, β-rays, γ-rays, and the like), microwaves, radio frequency, and is not particularly limited. A form of the energy ray source uses, for example, a dot light source, or a line light source, but is not particularly limited, and may be used by combining the dot light source with the line light source. In a case of using the dot light source as the energy ray source, it is preferable to form a line light source by arranging a plurality of dot line sources in a straight line shape. The line light source is preferably disposed in parallel to the rotation axis of the roll stamper 101. Examples of the energy ray source emitting the ultraviolet rays include a low pressure mercury lamp, a high pressure mercury lamp, a short-arc discharge lamp, an ultraviolet emitting diode, a semiconductor laser, a fluorescent lamp, organic electro-luminescence, inorganic electro-luminescence, a light emitting diode, an optical fiber, and the like, but are not particularly limited thereto. In addition, a slit is further provided inside the roll stamper 101, and the energy ray curable resin composition 118 may be irradiated with the energy ray from the energy ray sources 110 via the slit. At this time, the energy ray curable resin composition 118 may be cured by heat generated by absorbing the energy rays.

Configuration of Roll Stamper Exposure Device

FIG. 5 is a schematic diagram illustrating an example of a configuration of a roll stamper exposure device for manufacturing the roll stamper. The roll stamper exposure device is based on an optical disc recording device.

A laser light source 21 is a light source for exposing a resist formed on the surface of the roll stamper 101 as a recording medium, and oscillates recording laser light 104 of, for example, a wavelength λ=266 nm. The laser light 104 emitted from the laser light source 21 rectilinearly propagates in a parallel beam state and is incident to an electro-optical modulator (EOM) 22. The laser light 104 passing through the electro-optical modulator 22 is reflected by a mirror 23 and is guided to a modulation optical system 25.

The mirror 23 includes a polarization beam splitter, and reflects one polarization component and transmits the other polarization component beam therethrough. The polarization component passing through the mirror 23 is sensed by a photodiode 24, and a phase of the laser light 104 is modulated by controlling the electro-optical modulator 22 based on the sensed signal.

In the modulation optical system 25, the laser light 104 is collected at an acousto-optic modulator (AOM) 27 made of glass (SiO₂) by a condensing lens 26. The laser light 104 modulates its intensity by the acousto-optic modulator 27 and is diffused, and then is changed to a parallel beam by a lens 28. The laser light 104 emitted from the modulation optical system 25 is reflected by a mirror 31 and is guided to a movable optical table 32 in a horizontal and parallel manner.

The movable optical table 32 includes a beam expander 33, and an objective lens 34. The laser light 104 guided to the movable optical table 32 is formed to a desired beam shape by the beam expander 33, and then is applied to a resist layer on the roll stamper 101 via the objective lens 34. The roll stamper 101 is placed on a turntable 36 connected to a spindle motor 35. The resist layer is intermittently irradiated with the laser light while rotating the roll stamper 101 and moving the laser light 104 in the height direction of the roll stamper 101, thereby performing the exposure process for the resist layer. A formed latent image has a substantially elliptical shape having the long axis in the circumferential direction. The movement of the laser light 104 is performed through the movement of the movable optical table 32 in the direction of the arrow R.

The exposure device has a control mechanism 37 for forming a latent image corresponding to a two-dimensional pattern such as, for example, a hexagonal grid or a quasi-hexagonal grid shown in FIG. 1C, on the resist layer. The control mechanism 37 includes a formatter 29 and a driver 30. The formatter 29 includes a polarity reversing unit, and the polarity reversing unit controls application timing of the laser light 104 to the resist layer. The driver 30 controls the acousto-optic modulator 27 in response to an output from the polarity reversing unit.

In the roll stamper exposure device, a signal for synchronizing the polarity reversion formatter signal with a rotation controller of the recording device is generated such that two-dimensional patterns are linked spatially, and the intensity thereof is modulated by the acousto-optic modulator 27. A hexagonal grid pattern or a quasi-hexagonal grid pattern can be recorded through patterning at a constant angular velocity (CAV), at an appropriate rotation number, at an appropriate modulation frequency, and at an appropriate feed length. For example, if the cycle in the circumferential direction is set to 315 nm, and the cycle in the direction of 60 degrees (about −60 degrees) with respect to the circumferential direction is set to 300 nm, the feed length may be se to 251 nm (the Pythagoras' theorem). A frequency of the polarity reversion formatter signal is varied depending on a rotation number (for example, 1800 rpm, 900 rpm, 450 rpm, and 225 rpm) of the roll. The frequencies of the polarity reversion formatter signal corresponding to the respective rotation numbers 1800 rpm, 900 rpm, 450 rpm, and 225 rpm are 37.70 M Hz, 18.85 MHz, 9.34 MHz, and 4.71 MHz of the roll. Quasi-hexagonal grid patterns having the same spatial frequency (the cycle of 315 nm in the circumferential direction, and the cycle of 300 nm in the direction of 60 degrees (about −60 degrees) with respect to the circumferential direction) at a desired recording region can be obtained by expanding a diameter of a far-ultraviolet laser beam by five times using the beam expander (BEX) 33 on the movable optical table 32, and applying the laser beam to the resist layer on the roll stamper 101 via the objective lens 34 of the numerical aperture (NA) 0.9 so as to form minute latent images.

Manufacturing Method of Laminated Body

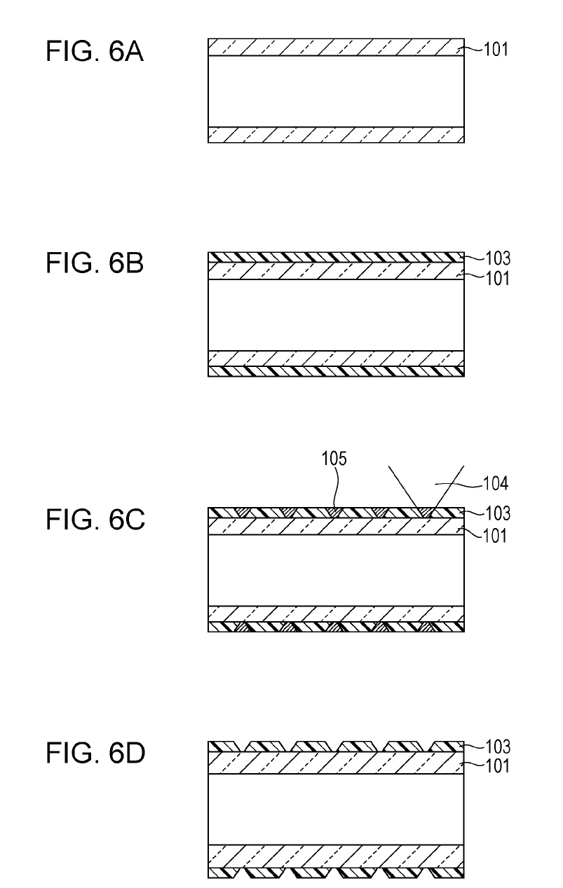

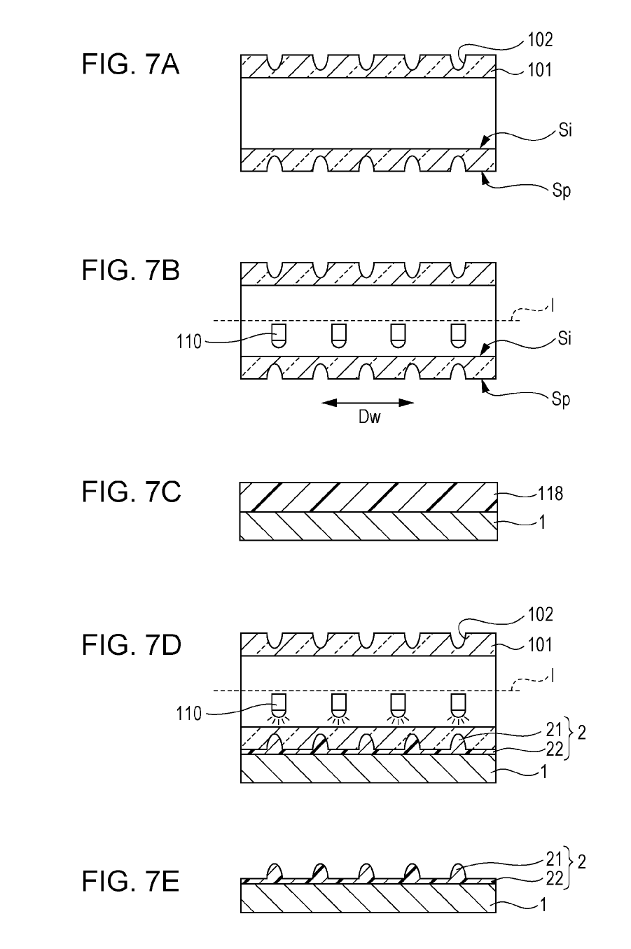

FIGS. 6A to 7E are process diagrams illustrating an example of a manufacturing method of the laminated body according to the first embodiment of the present disclosure.

Resist Layer Forming Process

First, as shown in FIG. 6A, a cylindrical roll stamper 101 is prepared. Next, as shown in FIG. 6B, a resist layer 103 is formed on the surface of the roll stamper 101. A material of the resist layer 103 may use either an organic resist or an inorganic resist. The organic resist may use, for example, a Novolak resist, a chemically amplified resist, or the like. In addition, the inorganic resist may use, for example, a metal compound including, for example, one or two or more kinds of transition metals.

Exposure Process

Next, as shown in FIG. 6C, the resist layer 103 formed on the surface of the roll stamper 101 is irradiated with the laser light (exposure beam) 104. Specifically, the roll stamper 101 is placed on the turntable 36 of the roll stamper exposure device shown in FIG. 5 and is rotated, and the resist layer 103 is irradiated with the laser light (exposure beam) 104. At this time, the resist layer 103 is entirely exposed by being intermittently irradiated with the laser light 104 while moving the laser light 104 in the height direction of the roll stamper 101 (the direction parallel to the central axis of the columnar or cylindrical roll stamper 101). Thereby, latent images 105 according to the trajectories of the laser light 104 are formed on the entire surface of the resist layer 103 with a pitch which is substantially the same as the wavelength of the visible light.

For example, the latent images 105 are disposed to form a plurality of lines of tracks on the stamper surface, and form the hexagonal grid pattern or the quasi-hexagonal grip pattern. The latent images 105 have, for example, elliptical shapes having the long axis in the extending direction of the track.

Developing Process

Next, a developing solution is dropped on the resist layer 103 while rotating the roll stamper 101, and, as shown in FIG. 6D, the resist layer 103 is developed. As shown in the figure, in a case where the resist layer 103 is formed using a positive resist, the exposed parts which are exposed by the laser light 104 have a melting rate higher than the non-exposed parts with respect to the developing solution, and thus the pattern corresponding to the latent images (exposed parts) 105 is formed on the resist layer 103.

Etching Process

Next, the surface of the roll stamper 101 is etched by using the pattern (resist pattern) of the resist layer 103 formed on the roll stamper 101 as a mask. Thereby, as shown in FIG. 7A, it is possible to obtain concave portions of an elliptic cone shape or a circular truncated cone having the long axis in the extending direction of the tracks, that is, structure bodies 102. The etching method may use, for example, dry etching or wet etching.

Ray Source Arrangement Process

Next, as shown in FIG. 7B, one or a plurality of energy ray sources 110 are disposed in the containing space (hollow portion) inside the roll stamper 101. The electro-optical device 100 is preferably disposed in the width direction Dw of the roll stamper 101 or so as to be parallel to the axial direction of the rotation axis 1.

Transfer Process

Next, optionally, a surface treatment such as a corona treatment, a plasma treatment, a flame treatment, a UV treatment, an ozone treatment, or a blast treatment is performed for the surface of the base 1 on which the energy ray curable resin composition 118 will be applied. Next, as shown in FIG. 7C, the energy ray curable resin composition 118 is applied or printed on the long base 1 or the roll stamper 101. The application method is particularly not limited, but, may use, for example, potting, a spin coating method, a gravure coating method, a die coating method, a bar coating method, or the like. The printing method may use, for example, a letterpress printing method, an offset printing method, a gravure printing method, an intaglio printing method, a rubber plate printing method, a screen printing method, or the like. In addition, optionally, a heating process such as a removal of solvent or pre-bake is performed.

Next, as shown in FIG. 7D, during the rotation of the roll stamper 101, the transfer surface Sp comes into close contact with the energy ray curable resin composition 118, and the energy ray emitted from the energy ray sources 110 inside the roll stamper 101 is applied to the energy ray curable resin composition 118 from the transfer surface Sp side of the roll stamper 101. Thereby, the energy ray curable resin composition 118 is cured, and thus the shape layer 2 is formed. Specifically, the curing reaction of the energy ray curable resin composition 118 proceeds from the transfer surface Sp of the roll stamper 101 to the front surface of the base 1, and the entire energy ray curable resin composition 118 is cured, thereby forming the shape layer 2. Whether or not the basal layer 22 is present, or the thickness of the basal layer 22 can be selected by, for example, adjusting the pressure of the roll stamper 101 to the front surface of the base 1. Next, the shape layer 2 formed on the base 1 is peeled from the transfer surface Sp of the roll stamper 101. Thereby, as shown in FIG. 7E, it is possible to obtain the laminated body where the shape layer 2 is formed on the front surface of the base 1. In the transfer process, the concave and convex shapes are transferred using the longitudinal direction of the base 1 as the rotation proceeding direction of the roll stamper 101.

Here, a transfer process using the transfer device shown in FIG. 3 will be described in detail.

First, the long base 1 is sent from the base supply roll 111, and the sent base 1 passes under the application unit 117. Next, the energy ray curable resin composition 118 is applied on the base 1 passing under the application unit 117, by the application unit 117. Thereafter, the base 1 on which the energy ray curable resin composition 118 is applied is carried to the roll stamper 101 via the guide roll 113.

Next, the carried-in base 1 is pinched by the roll stamper 101 and the nip roll 115 such that bubbles do not enter between the base 1 and the energy ray curable resin composition 118. Thereafter, the energy ray curable resin composition 118 comes into close contact with the transfer surface Sp of the roll stamper 101, the base 1 is carried along the transfer surface Sp of the roll stamper 101, and the energy ray curable resin composition 118 is irradiated with the energy rays emitted from one or a plurality of energy ray sources 110, via the transfer surface Sp of the roll stamper 101. Thereby, the energy ray curable resin composition 118 is cured, thereby forming the shape layer 2. Next, the shape layer 2 is peeled from the transfer surface Sp of the roll stamper 101 by the peeling roll 116, thereby obtaining the long laminated body. Then, the obtained laminated body is carried to the wind-up roll 112 via the guide roll 114, and the long laminated body is wound on the wind-up roll 112. Therefore, it is possible to obtain a stamper on which the long laminated body is wound.

### 2. Second Embodiment

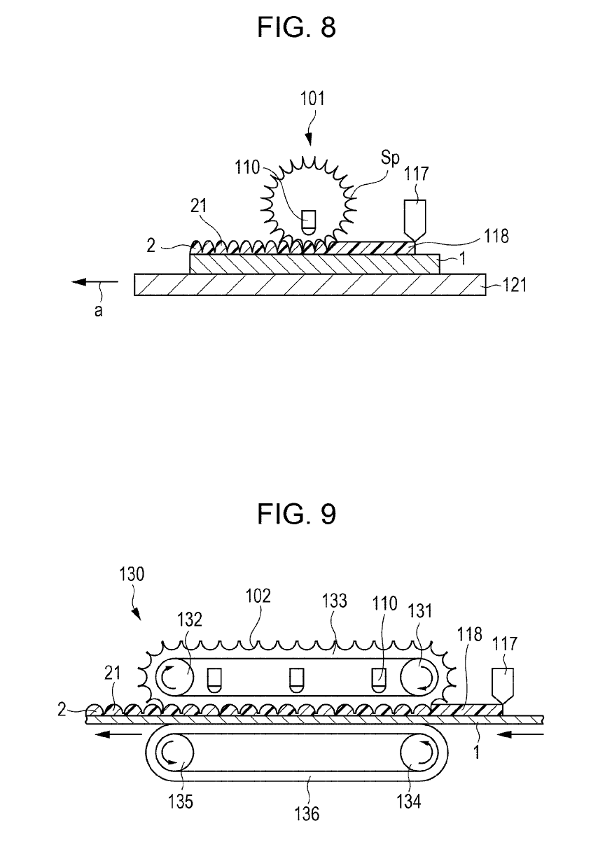

FIG. 8 is a schematic diagram illustrating an example of a configuration of a transfer device according to a second embodiment of the present disclosure. The transfer device includes a roll stamper 101, an application unit 117, and a carrying stage 121. In the second embodiment, the same elements as in the first embodiment are given the same reference numerals, and description thereof will be omitted. The carrying stage 121 is configured to carry the base 1 placed on the carrying stage 121 in the direction of the arrow a.

Next, an example of an operation of the transfer device having the above-described configuration will be described.

First, the energy ray curable resin composition 118 is applied on the base 1 passing under the application unit 117, by the application unit 117. Next, the base 1 on which the energy ray curable resin composition 118 is applied is carried to the roll stamper 101. Then, the energy ray curable resin composition 118 comes into close into contact with the transfer surface Sp of the roll stamper 101 and is carried, and energy rays emitted from one or a plurality of energy ray sources 110 provided inside the roll stamper 101 are applied to the energy ray curable resin composition 118 via the transfer surface Sp of the roll stamper 101. Thereby, the energy ray curable resin composition 118 is cured, thereby forming the shape layer 2. Next, the carrying stage is carried in the direction of the arrow a, thereby peeling the shape layer 2 from the transfer surface Sp of the roll stamper 101. Therefore, it is possible to obtain a long laminated body. Thereafter, the obtained laminated body is optionally cut out with a predetermined size or shape. As described above, a desired laminated body can be obtained.

### 3. Third Embodiment

FIG. 9 is a schematic diagram illustrating an example of a transfer device according to a third embodiment of the present disclosure. The transfer device includes rolls 131, 132, 134 and 135, an embossed belt 133 which is a belt stamper, a planarized belt 136, one or a plurality of energy ray sources 110, and an application unit 117. In the third embodiment, the same elements as in the first embodiment are given the same reference numerals, and description thereof will be omitted.

The embossed belt 133 is an example of a belt stamper and has a ring shape, and, a plurality of structure bodies 102 are arranged on the outer peripheral surface, for example, in a two-dimensional manner. The embossed belt 133 has a transmissive property with respect to the energy ray. The planarized belt 136 has a ring shape, and the outer peripheral surface is planarized. A gap corresponding to the thickness of the base 1 is formed between the embossed belt 133 and the planarized belt 136, and the base 1 on which the energy ray curable resin composition 118 is applied can travel between the belts.

The roll 131 and the roll 132 are disposed to be spaced apart from each other, and the embossed belt 133 is maintained to be in a long and thin elliptical shape by being supported by the inner peripheral surface thereof due to the roll 131 and the roll 132. The embossed belt 133 rotatably travels by rotatably driving the roll 131 and the roll 132 disposed inside the embossed belt 133.

The roll 134 and the roll 135 are disposed to be opposite to the roll 131 and the roll 132. The planarized belt 136 is maintained to be in a long and thin elliptical shape by being supported by the inner peripheral surface thereof due to the roll 134 and the roll 135. The planarized belt 136 rotatably travels by rotatably driving the roll 134 and the roll 135 disposed inside the planarized belt 136.

One or a plurality of energy ray sources 110 are disposed inside the embossed belt 133. One or a plurality of energy ray sources 110 are maintained to irradiate the base 1 traveling between the embossed belt 133 and the planarized belt 136 with energy rays. The energy ray sources 110 such as a line light source is preferably disposed to be parallel to the width direction of the embossed belt 133. The energy ray sources 110 may be disposed inside a space formed by the inner peripheral surface of the embossed belt 133, and is not particularly limited. For example, the energy ray sources 110 may be disposed at least one of the roll 131 and the roll 132. In this case, the roll 131 and the roll 132 are preferably made of a material having a transmissive property with respect to energy rays.

Next, an example of an operation of the transfer device having the above-described configuration will be described.

First, the energy ray curable resin composition 118 is applied on the base 1 passing under the application unit 117, by the application unit 117. Next, the base 1 on which the energy ray curable resin composition 118 is applied is carried in the gap between the rotated embossed belt 133 and planarized belt 136 from the rolls 131 and 134. Thereby, the transfer surface of the embossed belt 133 comes into close contact with the energy ray curable resin composition 118. Next, in a close contact state, the energy ray curable resin composition 118 is irradiated with energy rays emitted from the energy ray sources 110 via the embossed belt 133. Therefore, the energy ray curable resin composition 118 is cured, thereby forming the shape layer 2. Next, the embossed belt 133 is peeled from the shape layer 2. Thereby, a desired laminated body can be obtained.

### 4. Fourth Embodiment

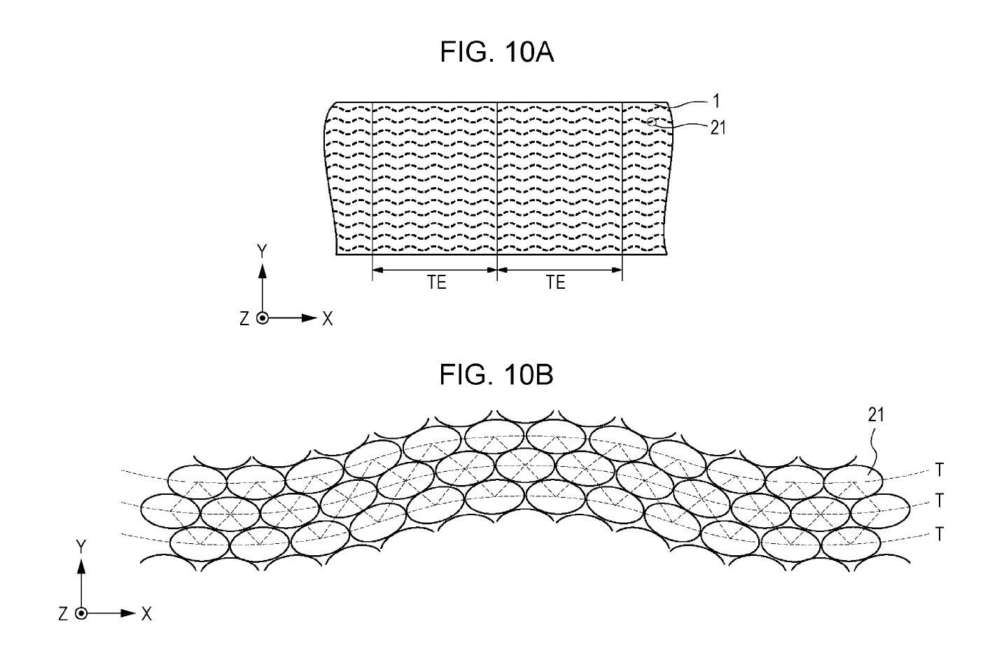

FIG. 10A is a plan view illustrating an example of a configuration of a laminated body according to a fourth embodiment of the present disclosure. FIG. 10B is an enlarged plan view of a part of the laminated body shown in FIG. 10A. The laminated body according to the fourth embodiment of the present disclosure is different from the laminated body according to the first embodiment of the present disclosure in that the structure bodies 21 are arranged on a wobble track. The wobbles for the respective tracks on the base 1 are preferably synchronized with each other. That is to say, the wobbles are preferably synchronized wobbles. A unit grid shape such as a hexagonal grid or a quasi-hexagonal grid is maintained by synchronizing the wobbles with each other, and thus it is possible to maintain a filling rate to be high. A waveform of the wobble track includes, for example, a sine curve, a triangular wave, and the like, but is not limited thereto. The waveform of the wobble track is not limited to the cyclic waveform but may be an acyclic waveform.

The fourth embodiment is the same as the first embodiment except for the above description.

### 5. Fifth Embodiment

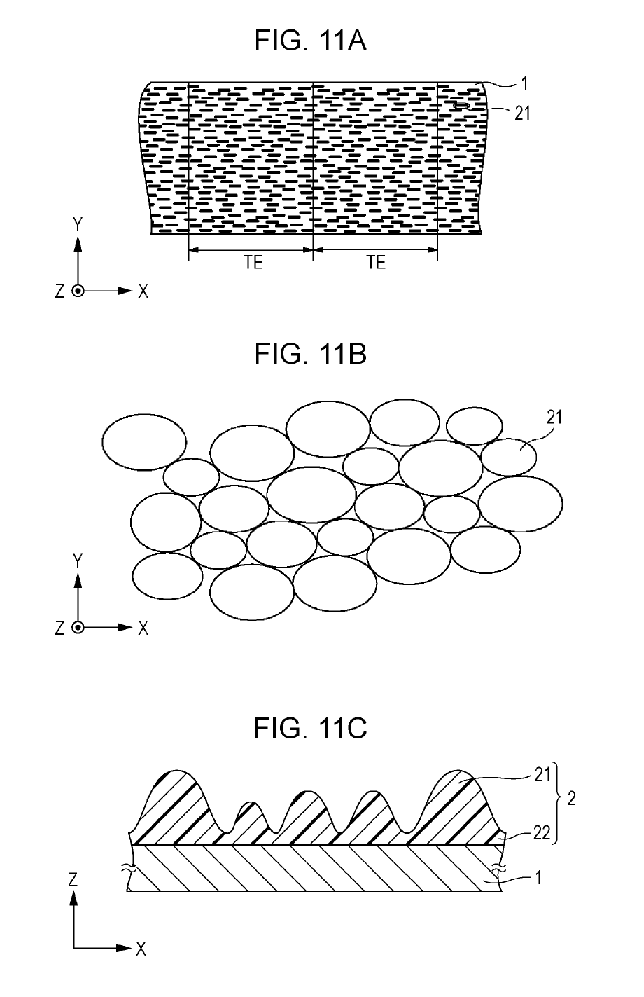

FIG. 11A is a cross-sectional view illustrating an example of a configuration of a laminated body according to a fifth embodiment of the present disclosure. FIG. 11B is an enlarged plan view of a part of the laminated body shown in FIG. 11A. FIG. 11C is a cross-sectional view of the laminated body shown in FIG. 11B. The laminated body according to the fourth embodiment is different from the laminated body according to the first embodiment in that a plurality of structure bodies 21 are arranged randomly (irregularly) in a two-dimensional manner. In addition, the size and/or the height of the structure body 21 may be varied randomly.

The fifth embodiment is the same as the first embodiment except for the above description.

### 6. Sixth Embodiment

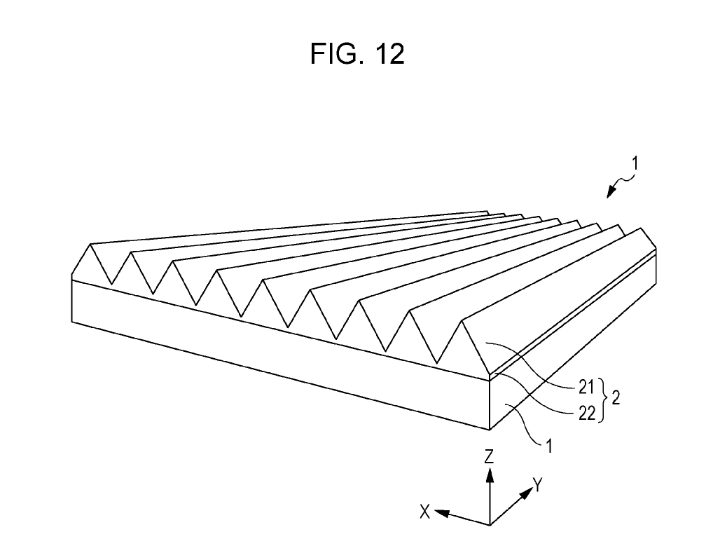

FIG. 12 is a perspective view illustrating an example of a configuration of a laminated body according to a sixth embodiment. As shown in FIG. 12, the laminated body according to the sixth embodiment is different from the laminated body according to the first embodiment in that it has a columnar structure body 21 extending in one direction on the front surface of the base, and the structure body 21 is arranged in a one-dimensional manner.

A cross-sectional shape of the structure body 21 includes, for example, a triangular shape, a triangular shape of which a top has a curvature R, a polygonal shape, a hemispherical shape, a semi-elliptical shape, a parabolic shape, a toroidal shape, and the like, but is not particularly limited. In addition, the structure body 21 may wobble and extend in one direction.

The sixth embodiment is the same as the first embodiment except for the above description.

### 7. Seventh Embodiment

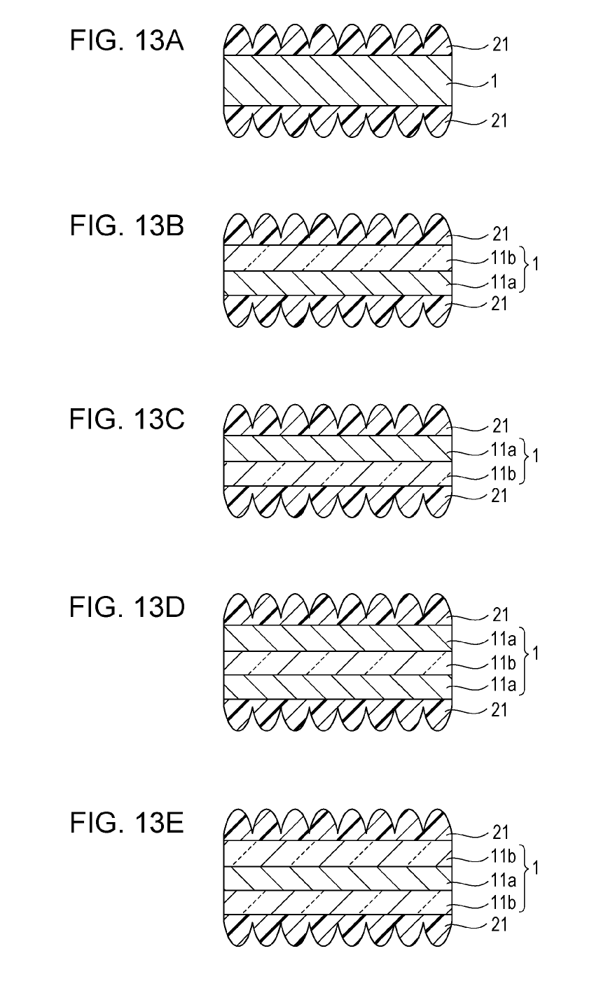

FIGS. 13A to 13E are cross-sectional views illustrating first to fifth examples of bases provided in a laminated body according to a seventh embodiment of the present disclosure. The laminated body according to the seventh embodiment is different from the laminated body according to the first embodiment in that a plurality of structure bodies 21 are arranged on both of the main surfaces of the base 1 in a two-dimensional manner. Specifically, the laminated bodies of the first to fifth examples are respectively the same as the first to fifth examples of the laminated bodies according to the first embodiment (refer to FIG. 2) except that a plurality of structure bodies 21 are arranged on both of the main surfaces of the base 1.

The seventh embodiment is the same as the first embodiment except for the above description.

### 8. Eighth Embodiment

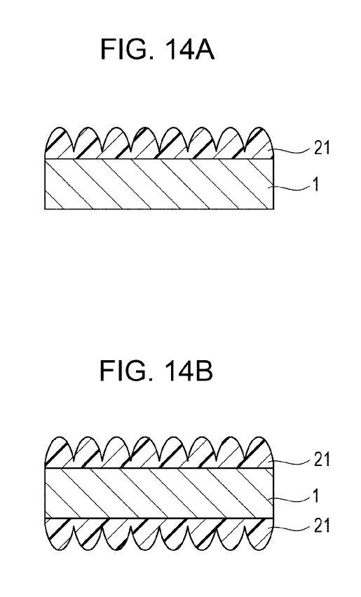

FIG. 14A is a cross-sectional view illustrating a first example of a base provided in a laminated body according to an eighth embodiment of the present disclosure. FIG. 14B is a cross-sectional view illustrating a second example of a base provided in the laminated body according to the eighth embodiment. The laminated body is different from the laminated body according to the first embodiment or the seventh embodiment in that the structure bodies 21 have a non-transmissive property with respect to energy rays. The structure bodies 21 having a non-transmissive property may be formed by, for example, adding a material such as a pigment absorbing energy rays to the energy ray curable resin composition.

The eighth embodiment is the same as the first embodiment except for the above description.

As such, although the embodiments of the present disclosure have been described in detail, the present disclosure is not limited to the above-described embodiments, but may have a variety of modifications based on the technical spirit of the present disclosure.

For example, the configurations, the processes, the methods, the shapes, the materials, and the numerical values described in the embodiments are only an example, and configuration, processes, methods, shapes, materials, and numerical values different therefrom may be used as necessary.

In addition, the configurations, the processes, the methods, the shapes, the materials, and the numerical values described in the embodiments may be combined with each other without departing from the scope of the present disclosure.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A manufacturing method of a laminated body comprising:
applying an energy ray curable resin composition on a base; and
causing a rotation surface of a rotation stamper to come into close contact with the energy ray curable resin composition applied on the base during rotation, and irradiating the energy ray curable resin composition with energy rays emitted from one or a plurality of energy ray sources provided in the rotation stamper via the rotation surface so as to cure the energy ray curable resin composition, thereby forming a shape layer onto which concave and convex shapes of the rotation surface are transferred, on the base.

2. The manufacturing method of the laminated body according to claim 1, wherein the base has a non-transmissive property with respect to the energy rays.

3. The manufacturing method of the laminated body according to claim 1, wherein the concave and convex shapes of the rotation surface are formed by arranging a plurality of structure bodies having a convex shape or a concave shape in a one-dimensional manner or in a two-dimensional manner.

4. The manufacturing method of the laminated body according to claim 3, wherein the plurality of structure bodies are disposed regularly or irregularly.

5. The manufacturing method of the laminated body according to claim 3, wherein the plurality of structure bodies are sub-wavelength structure bodies.

6. The manufacturing method of the laminated body according to claim 1, wherein the rotation stamper is a roll stamper or a belt stamper.

7. The manufacturing method of the laminated body according to claim 1, wherein the one or the plurality of energy ray sources are arranged in a width direction of the rotation stamper.

8. The manufacturing method of the laminated body according to claim 1, wherein the base has a strip shape, and
wherein in the forming of the shape layer, the concave and convex shapes are transferred by setting a longitudinal direction of the base as a rotation proceeding direction.

9. The manufacturing method of the laminated body according to claim 1, wherein the base includes at least one plane or curve, and
wherein the shape layer is formed on the plane or the curve.

10. A transfer device comprising:
a rotation surface having concave and convex shapes; and
a rotation stamper having one or a plurality of energy ray sources provided inside the rotation surface,
wherein the rotation stamper has a transmissive property with respect to energy rays emitted from the energy ray source, and
wherein the rotation surface of the rotation stamper comes into close contact with an energy ray curable resin composition applied on a base during rotation, and the energy ray curable resin composition is irradiated with the energy ray emitted from the energy ray source provided in the rotation stamper via the rotation surface so as to cure the energy ray curable resin composition, thereby forming a shape layer onto which concave and convex shapes of the rotation surface are transferred, on the base.

11. A stamper comprising a rotation surface having concave and convex shapes,
wherein the stamper has a transmissive property with respect to energy rays emitted from an energy ray source, and
wherein the stamper causes an energy ray curable resin composition to be irradiated with the energy rays emitted from the energy ray source via the rotation surface, thereby curing the energy ray curable resin composition.

12. A laminated body comprising:
a base; and
a shape layer having a surface which is formed on the based and has concave and convex shapes,
wherein the shape layer is formed by curing an energy ray curable resin composition,
wherein a unit region having a predetermined concave and convex pattern is continuously formed on the surface of the shape layer without generating mismatching between the concave and convex shapes, and
wherein the base has a non-transmissive property with respect to energy rays for curing the energy ray curable resin composition.

13. The laminated body according to claim 12, wherein the base has a strip shape, and
wherein the unit region is continuously formed in a longitudinal direction of the base.

14. The laminated body according to claim 12, wherein the mismatching between the concave and convex shapes is disarray of periodicity of the predetermined concave and convex pattern.

15. The laminated body according to claim 12, wherein the mismatching between the concave and convex shapes is overlapping or a gap between adjacent unit regions, or a portion where transfer is not performed.

16. The laminated body according to claim 12, wherein the unit regions are connected to each other without generating mismatching in a curing extent of the energy ray curable resin composition.

17. The laminated body according to claim 16, wherein the mismatching in the curing extent of the energy ray curable resin composition is a difference in a degree of polymerization.

18. The laminated body according to claim 12, wherein the shape layer is formed by causing a curing reaction of the energy ray curable resin composition applied on the base to proceed from an opposite side to the base.

19. The laminated body according to claim 12, wherein the unit region is a transfer region formed by rotating a rotation surface of a rotation stamper.

20. The laminated body according to claim 12, wherein the concave and convex pattern is formed by arranging a plurality of structure bodies having a convex shape or a concave shape in a one-dimensional manner or in a two-dimensional manner.

21. The laminated body according to claim 20, wherein the plurality of structure bodies are disposed regularly or irregularly.

22. The laminated body according to claim 20, wherein the plurality of structure bodies are sub-wavelength structure bodies.

23. The laminated body according to claim 12, wherein the base includes at least one plane or curve, and
wherein the shape layer is formed on the plane or the curve.

24. A laminated body comprising:
a base having a first surface and a second surface opposite to the first surface;
a first shape layer formed on the first surface of the base; and
a second shape layer formed on the second surface of the base,
wherein the first shape layer is formed by curing an energy ray curable resin composition,
wherein at least the second shape layer of the first and second shape layers has a non-transmissive property with respect to energy rays for curing the energy ray curable resin composition, and
wherein a unit region having a predetermined concave and convex pattern is continuously formed on a surface of the first shape layer without generating mismatching between the concave and convex shapes.

25. A molding element comprising the laminated body according to claim 12.

26. An optical element comprising the laminated body according to claim 12.
